(19) United States
(12) Patent Application Publication
(10) Pub. No.: US 2023/0418725 A1
(43) Pub. Date: Dec. 28, 2023

(54) CODE RISK ANALYSIS TOOL

(71) Applicant: Wells Fargo Bank, N.A., San Francisco, CA (US)

(72) Inventors: Nathan Charles Freeling, Lafayette, CA (US); Catherine Guangning Li, Corte Madera, CA (US); Iain Thomas Raleigh, Tujunga, CA (US)

(21) Appl. No.: 16/016,026

(22) Filed: Jun. 22, 2018

(51) Int. Cl. G06F 11/36; G06F 8/20; G06N 99/00

(52) U.S. Cl. CPC G06F 11/3604; G06F 8/20; G06N 99/005

(57) ABSTRACT

The innovation disclosed and claimed herein, in one aspect thereof, comprises systems and methods of reviewing submitted programming solutions in response to a requested task. The innovation receives a solution for a task that is part of a project. The innovation analyzes the solution and the user according to a set of predetermined rules. The innovation determines a set of predetermined rules based on an analysis of previously received solutions. The innovation determines similarities between the received solution to previously received solutions. The innovation determines a subset of previously received solutions that are most similar to the received solution. The innovation analyzes the subset of previously received solutions, including a history of each solution in the subset. The innovation determines a likelihood of faults in the received solution based on the analysis of the subset.

### BACKGROUND

Increasingly software projects are divided into smaller tasks. The tasks can be posted by an entity to a public or private forum where solutions to the tasks can be submitted. The solutions are typically segments of code in a programming language that solves or answers the requested task. Typically the solutions are reviewed manually on an individual basis. However, there is need for a more robust analysis of the solutions to tasks to determine how the solutions relate to the overlying software project.

### BRIEF SUMMARY OF THE DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of reviewing coding using machine learning. A method of the innovation includes providing a review portal through which a user can submit a solution for a task that is part of a project, the solution is programming code for a software development task. The review portal receives a solution from a user for a posted task. The solution and the user are analyzed according to a set of predetermined rules. An analysis report is generated, the report includes the results of the analysis of the solution and the user. The analysis report is provided to the review portal such that the analysis report is associated with the task, the solution, and the user.

A system of the innovation can include a review portal through which a user submits a solution for a task that is part of a project, the solution is programming code for a software development task. An analysis component analyzes the solution and the user according to a set of predetermined rules. A report component generates an analysis report including the results of the analysis of the solution and the user. A communication component provides the analysis report to the review portal such that the analysis report is associated with the task, the solution, and the user.

A computer readable medium of the innovation has instructions receive a solution for a task that is part of a project, the solution is programming code for a software development task. The instructions include analyzing the solution and the user according to a set of predetermined rules. The instructions include determining a set of predetermined rules based on an analysis of previously received solutions. The instructions include determining similarities between the received solution to previously received solutions. The instructions include determining a subset of previously received solutions that are most similar to the received solution. The instructions include analyzing the subset of previously received solutions, including a history of each solution in the subset. The instructions include determining a likelihood of faults in the received solution based on the analysis of the subset.

In aspects, the subject innovation provides substantial benefits in terms of reviewing submitted programming code for tasks. One advantage resides in an automated review or pre-review analysis of submitted programming to determine faults or bugs. Another advantage resides in learning and/or training an analysis over time to better review submitted code.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example component diagram of a system of the present innovation.

FIG. 2 illustrates an example component diagram of an analysis component.

FIG. 3 illustrates an example component diagram of a machine learning component.

FIG. 4 illustrates a method for analyzing solutions to software tasks.

FIG. 5 illustrates a computer-readable medium or computer-readable device comprising processor-executable instructions configured to embody one or more of the provisions set forth herein, according to some embodiments.

FIG. 6 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

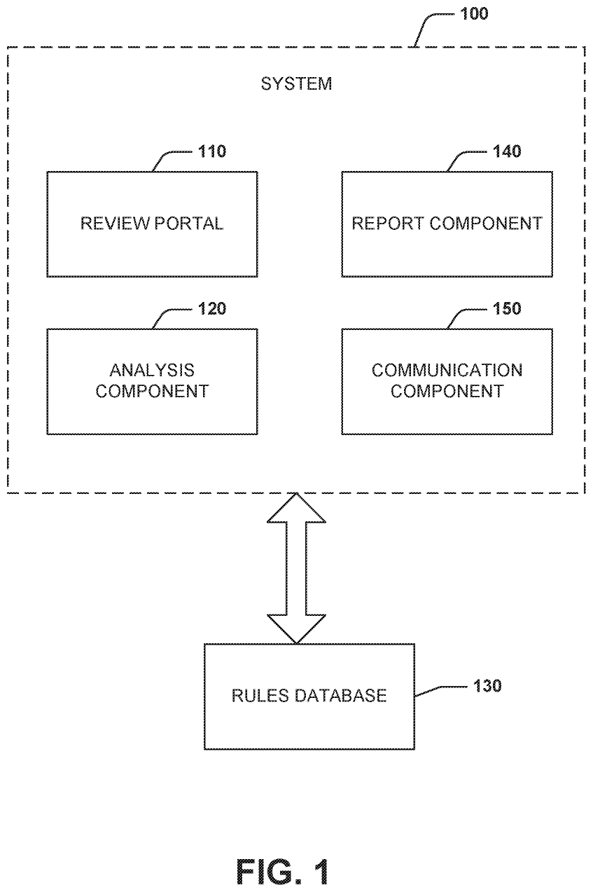

FIG. 1 illustrates a system 100 for providing a code review of a solution. The system 100 includes a review portal 110. The review portal 110 provides a portal (e.g. a website, forum, and/or the like) through which a user submits a solution for a task that is part of a project. In some embodiments, the review portal 110 is a third party review site or a product built upon a base third party review site, and/or the like. In other embodiments, the review portal 110 is implemented as a “plugin” or “application” deployed to a third-party review portal.

In some embodiments, the solution is programming code for a software development task posted to the review portal 110. In other embodiments, the review portal 110 determines access controls for the solution and/or the task. The access controls can determine who can view and/or post a solution or a task to the review portal 110. The review portal 110 determines a subset of predetermined rules based on the access controls to prevent potential malicious users or non-affiliated users from posting solutions. In some embodiments, the access controls depend upon the implementation of the review portal 110. The access controls may be globally readable subject to organization network restrictions.

The system 100 includes an analysis component 120. The analysis component 120 analyzes the solution and the user according to a set of predetermined rules. The analysis component 120 determines the set of predetermined rules based on an analysis of previously received solutions to software development tasks. The analysis includes examining aspects of the previously received solutions including a history of the previously received solutions such as number of faults in the previously received solutions, whether the solutions were merged or not merged, and/or the like. In some embodiments, the predetermined rules are trained or “learned” over time using machine learning algorithms and/or the like. In some embodiments, the analysis can include data from other systems such as: defect tracking systems, project management systems, security code analysis systems, static code analysis systems, build systems, continuous integration systems, and/or the like. The analysis component 120 develops the predetermined rules from the analysis to facilitate analyzing the presently received solution for a likelihood of faults. The predetermined rules can be stored in a rules database 130. The predetermined rules can include risk factors. In some embodiments, the risk factors include user historical data, the user historical data includes at least one of number of solutions merged, number of solutions rejected, number of solutions requiring debugging, and/or the like. In some embodiments, the predetermined rules can change based upon the coding language of the solution, the type of file under analysis, the codebase that contained the file under analysis, and/or the like.

In some embodiments, the analysis component 120 determines similarities between the received solution and the previous solutions. In other embodiments, the analysis component 120 determines a subset of previously received solutions that are most similar to the received solution. The analysis component 120 analyzes a history of each solution in the subset. The history includes number of faults found in the similar solutions, number of merges by the user, number of rejected merges of the user, and/or the like. The history is a factor in determining a likelihood of faults in the received solution based on the analysis of the subset. In some embodiments, the analysis component 120 updates the set of predetermined rules using a machine learning algorithm for analyzing the solution and analysis of future solutions.

The analysis component 120 applies the rules to the solution to determine a likelihood of faults within the received solution. For example, a rule can be amount time between posting a task and receiving a solution. An unreasonably short time can factor into a higher likelihood of faults occurring when the solution is merged. The analysis component 120 can determine the likelihood the solution will break a larger solution when merged. In some embodiments, the analysis component 120 uses machine learning to complete the analysis.

The system 100 includes a report component 140. The report component 140 generates an analysis report including the results of the analysis of the solution and the user. In some embodiments, the report component 140 can generate the report according to forum limitations, forum rules, or formatting requirements for posting to the review portal 110.

The system 100 includes a communication component 150. The communication component 150 provides the generated report to the review portal 110 such that the analysis report is associated with the task, the solution, and the user. In some embodiments, the communication component 150 generates a comment to the solution posted to the review portal 110, where the review portal 110 is a post and comment architecture. In some embodiments, the report is provided as an annotation on a specific line of code or a file in the review portal 110. In other embodiments, the report is provided as a task, marker, problem, task workspace, and/or a finding in the review portal 110. In some embodiments, the specific presentation of the report is governed by how findings are presented in the review portal's 110 implementation.

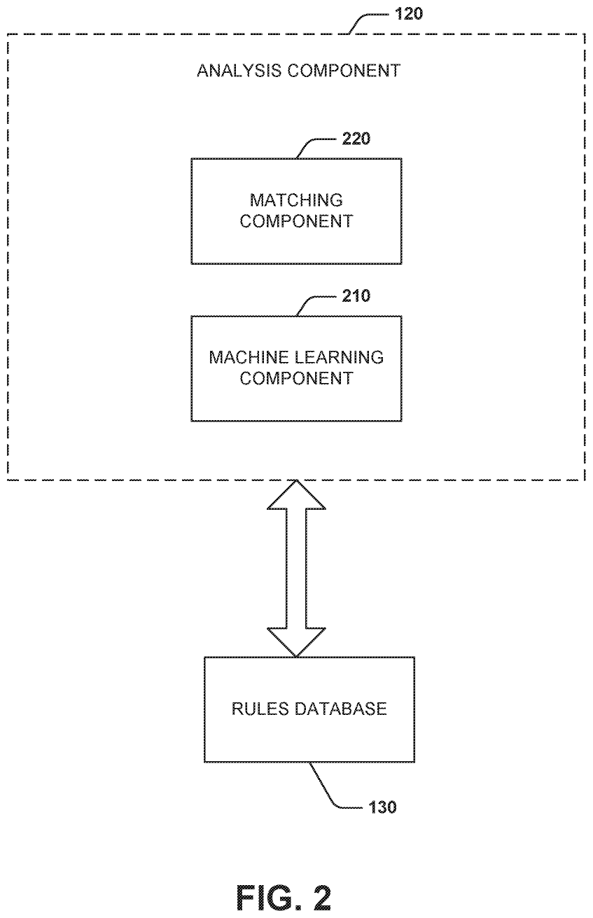

FIG. 2 illustrates a detailed component diagram of the analysis component 120. The analysis component 120 includes a machine learning component 210. The machine learning component 210 can determine a set of predetermined rules from the rules database 130 based on an analysis of previously received solutions to software development tasks. The machine learning component 210 examines aspects of the previously received solutions including a history of the previously received solutions such as number of faults in the previously received solutions, whether the solutions were merged or not merged, and/or the like. In some embodiments, the machine learning component 210 can determine trends between elements in previously received solutions and the subsequent treatment of the previously received solutions to facilitate learning the predetermined rules. For example, the machine learning component 210 determines a particular line of code in a previously received solution caused a fault that had to be cured before merging. The machine learning component 210 can develop a rule to look for similar code in future received solutions.

The machine learning component 210 develops the set of predetermined rules from the analysis to facilitate analyzing the presently received solution for a likelihood of faults. The predetermined rules can be stored in the rules database 130. The predetermined rules can include risk factors. In some embodiments, the risk factors include user historical data, the user historical data includes at least one of number of solutions merged, number of solutions rejected, number of solutions requiring debugging, and/or the like.

The analysis component 120 includes a matching component 220. The matching component 220 facilitates determining a likelihood of faults within the received solution by determining similarities between the received solution and the previous solutions. In some embodiments, the matching component 220 determines a subset of previously received solutions that are most similar to the received solution. The machine learning component 210 analyzes a history of each solution in the subset. The history includes number of faults found in the similar solutions, number of merges by the user, number of rejected merges of the user, and/or the like. The history is a factor in determining a likelihood of faults in the received solution based on the analysis of the subset. In some embodiments, the machine learning component 210 updates the set of predetermined rules using a machine learning algorithm for future analysis of solutions.

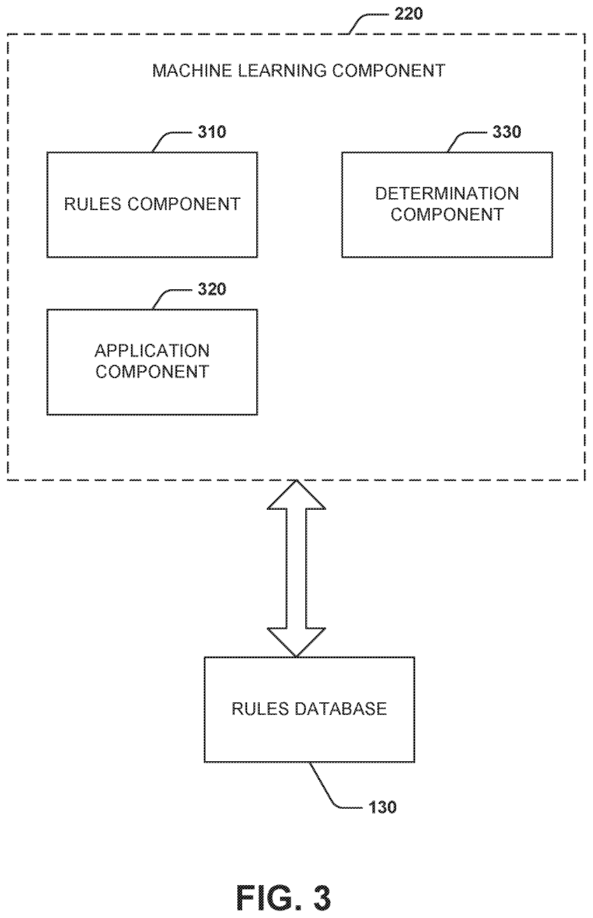

FIG. 3 illustrates a component diagram of a machine learning component 210. The machine learning component 210 includes a rules component 310. The rules component 310 applies the predetermined rules to the solution and/or previously received solutions. Example rules can include history of the user, history of previously received solutions, open tasks that use the same file, number of times the solution has been updated within a predetermined time period, lint reminders, how long the task has been available in relation to receiving the solution, and/or the like. Such rules can be considered risk factors in computing a solution risk score described below.

The machine learning component 210 includes an application component 320 that analyzes the solution according to the rules. In some embodiments, the application component 320 applies machine learning algorithms to analyze the solute according to the rules. In an example, the application component 320 analyzes a history of each solution in the subset of previously received solutions from the matching component 220. The history includes number of faults found in the similar solutions, number of merges by the user, number of rejected merges of the user, and/or the like. The history is a risk factor in determining a likelihood of faults in the received solution based on the analysis of the subset.

The machine learning component 210 includes a determination component 330 that determines the likelihood of faults and/or a solution risk score of the received solution. In some embodiments, the solution risk score is an aggregate score such that the determination component 210 determines a solution risk score for each of the rules described above and aggregates each score into an aggregate score. The aggregate score can be provided to the report component 140.

In some embodiments, the determination component 210 can determine a variety of metrics for the solution. In some embodiments, the determination component 210 uses machine learning to determine the metrics. For example, the determination component 210 can predict: a likelihood that a solution will be followed by another solution with an overlapping file-set within a predetermine time period, a likelihood that a solution will be merged into the overall project; a prediction of a number of review comments, labels, assignee & reviewer, functional area or software component from a predefined list of functional areas & components, a likelihood that a solution will break the build for long running builds that cannot complete a build for each solution, a likelihood that a solution will cause a high severity defect therefore a RCA exercise will be followed, a likelihood that a solution will cause production issue in which Production Support will be notified, likelihood of no commits in branch, frequency of file changes and/or the like.

The rules component 310 updates the set of predetermined rules using a machine learning algorithm for future analysis of solutions. The rules component 310 can refine the rules according to subsequent actions of the presently received solution. For example, a particular line of code in the solution cause a fault in the code when merged but was not determined to cause a fault in the previous analysis. The rules component 310 can create a rule such that similar lines of code in future solutions will factor into the predictive analysis of the future solution.

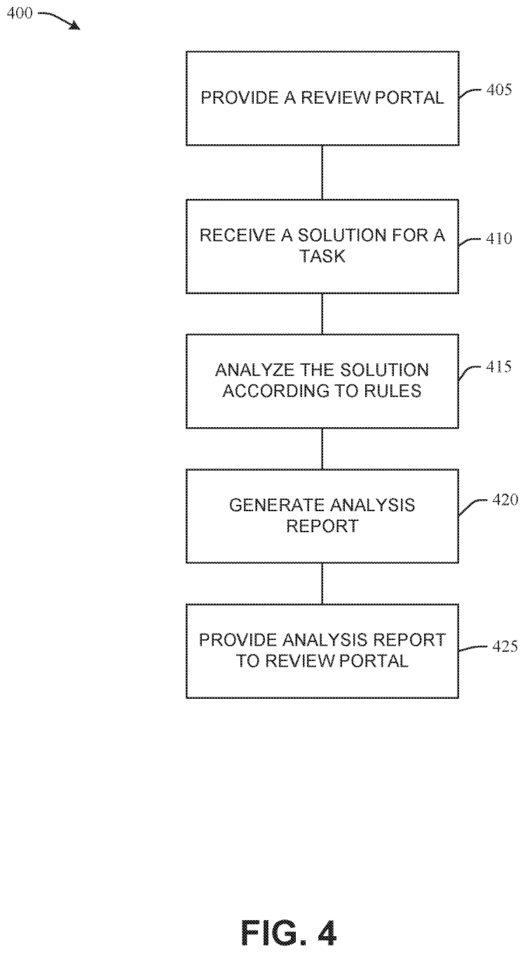

With reference to FIG. 4, example method 400 is depicted for authenticating a user to verify identity. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 400 is described in conjunction with a specific example is for explanation purposes.

FIG. 4 illustrates a method 400 for providing a review of a solution. At 405, a review portal is provided. The review portal can be a website, forum, internal review board, and/or the like where tasks are submitted and solutions to the tasks can be received. At 410, the review portal receives a solution for a particular task. The solution can be posted in association with the task in a new thread or comment to the task.

At 415, the solution is analyzed according to predetermined rules. The predetermined rules can be learned using machine learning analysis of previously received solutions and the histories of the previously received solutions. At 420, a report is generated for the analysis and the solution. At 425, the report is provided to the review portal such that it is associated with the solution and the task. In some embodiments, the report can be provided to the review portal as a comment on the solution.

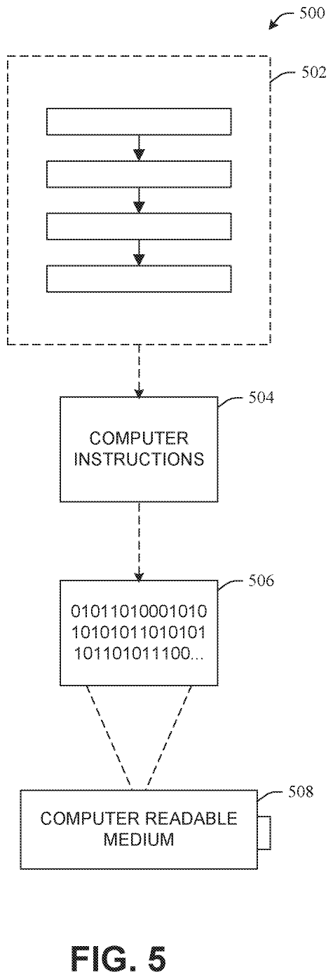

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 5, wherein an implementation 500 comprises a computer-readable medium 508, such as a CD-R, DVD-R, flash drive, a platter of a hard disk drive, etc., on which is encoded computer-readable data 506. This computer-readable data 506, such as binary data comprising a plurality of zero's and one's as shown in 506, in turn comprises a set of computer instructions 504 configured to operate according to one or more of the principles set forth herein. In one such embodiment 500, the processor-executable computer instructions 504 is configured to perform a method 502, such as at least a portion of one or more of the methods described in connection with embodiments disclosed herein. In another embodiment, the processor-executable instructions 504 are configured to implement a system, such as at least a portion of one or more of the systems described in connection with embodiments disclosed herein. Many such computer-readable media can be devised by those of ordinary skill in the art that are configured to operate in accordance with the techniques presented herein.

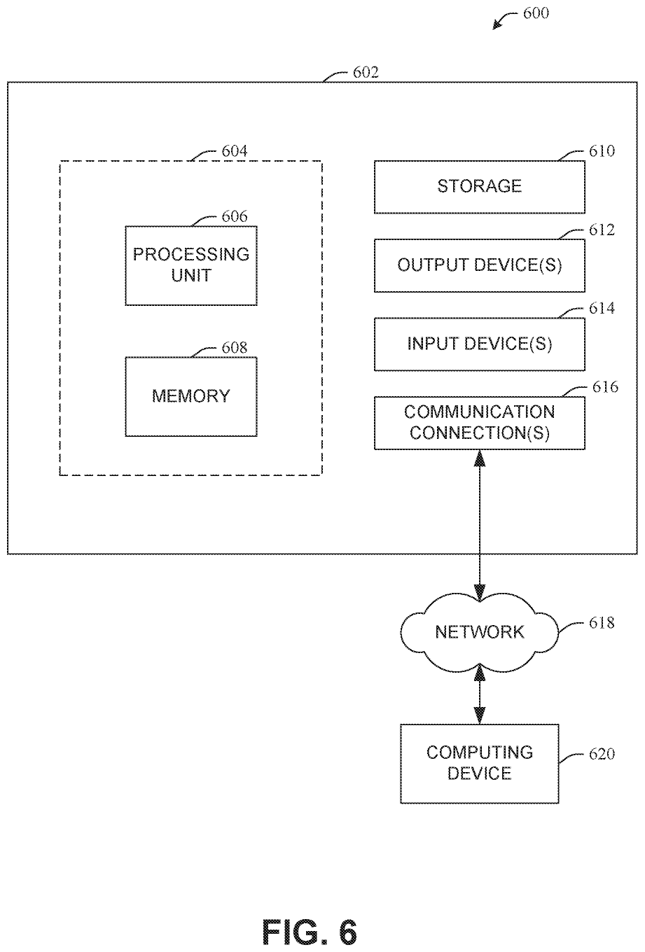

With reference to FIG. 6 and the following discussion provide a description of a suitable computing environment in which embodiments of one or more of the provisions set forth herein can be implemented. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 6 illustrates a system 600 comprising a computing device 602 configured to implement one or more embodiments provided herein. In one configuration, computing device 602 can include at least one processing unit 606 and memory 608. Depending on the exact configuration and type of computing device, memory 608 may be volatile, such as RAM, non-volatile, such as ROM, flash memory, etc., or some combination of the two. This configuration is illustrated in FIG. 6 by dashed line 604.

In these or other embodiments, device 602 can include additional features or functionality. For example, device 602 can also include additional storage such as removable storage or non-removable storage, including, but not limited to, magnetic storage, optical storage, and the like. Such additional storage is illustrated in FIG. 6 by storage 610. In some embodiments, computer readable instructions to implement one or more embodiments provided herein are in storage 610. Storage 610 can also store other computer readable instructions to implement an operating system, an application program, and the like. Computer readable instructions can be accessed in memory 608 for execution by processing unit 606, for example.

The term “computer readable media” as used herein includes computer storage media. Computer storage media includes volatile and nonvolatile, non-transitory, removable and non-removable media implemented in any method or technology for storage of information such as computer readable instructions or other data. Memory 608 and storage 610 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 602. Any such computer storage media can be part of device 602.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 602 can include one or more input devices 614 such as keyboard, mouse, pen, voice input device, touch input device, infrared cameras, video input devices, or any other input device. One or more output devices 612 such as one or more displays, speakers, printers, or any other output device can also be included in device 602. The one or more input devices 614 and/or one or more output devices 612 can be connected to device 602 via a wired connection, wireless connection, or any combination thereof. In some embodiments, one or more input devices or output devices from another computing device can be used as input device(s) 614 or output device(s) 612 for computing device 602. Device 602 can also include one or more communication connections 616 that can facilitate communications with one or more other devices 620 by means of a communications network 618, which can be wired, wireless, or any combination thereof, and can include ad hoc networks, intranets, the Internet, or substantially any other communications network that can allow device 602 to communicate with at least one other computing device 620.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1-9. (canceled)

10. A system, comprising:
a processor coupled to a memory storing instructions that when executed by the processor perform the following operations:
receiving a solution submitted by a first user to a task by way of a review portal, wherein the solution comprises programming code for a code review task initiated by a second user;
analyzing the solution and one or more prior solutions the first user according to a set of predetermined rules that determine a likelihood of a fault if the programming code of the solution is merged with existing programming code from the second user, wherein analyzing the solution includes using a machine learning component to identify a line of code from the solution matching a second line of code from the one to more prior solutions that caused a fault;
generating an analysis report including results of the analysis of the solution and the first user; and
transmitting the analysis report for display to the second user in conjunction with the solution by way of the review portal,
wherein the predetermined rules are determined based upon a coding language of the solution, and wherein the predetermined rules are updated based on analysis from the machine learning component.

11. The system of claim 10, the operations further comprising
determining the set of predetermined rules based on an analysis of previously received solutions.

12. The system of claim 10, the operations further comprising:
determining similarities between the received solution to previously received solutions; and
determining a subset of previously received solutions that are most similar to the received solution.

13. (canceled)

14. The system of claim 10, wherein the set of predetermined rules includes risk factors.

15. The system of claim 14, wherein the risk factors include user historical data, the user historical data includes at least one of number of solutions merged, number of solutions rejected, or number of solutions requiring debugging.

16. (canceled)

17. The system of claim 10, the operations further comprising:
generating an annotation, the annotation including at least some of the analysis report, wherein the annotation is associated with a specific line of code in the solution.

18. The system of claim 17, the operations further comprising:
determining access controls for the solution; and
determining a subset of predetermined rules based on the access controls.

19-22. (canceled)
